(19) United States
(12) Patent Application Publication
(10) Pub. No.: US 2008/0273754 A1
(43) Pub. Date: Nov. 6, 2008

(54) APPARATUS AND METHOD FOR DEFINING AN AREA OF INTEREST FOR IMAGE SENSING

(75) Inventors: Robert L. Hick, Newberg, OR (US); Richard A. Leinen, Wilsonville, OR (US); Paul S. Maddox, Tualatin, OR (US)

Correspondence Address: Marger Johnson & McCollom PC - Leviton, 210 SW Morrison, Suite 400, Portland, OR, 97204, US

(73) Assignee: LEVITON MANUFACTURING CO., INC., Little Neck, NY (US)

(21) Appl. No.: 12/113,890

(22) Filed: May 1, 2008

Related U.S. Application Data
(60) Provisional application No. 60/916,192, filed on May 4, 2007.

(51) Int. Cl. G06K 9/00

(52) U.S. Cl. 382/103

(57) ABSTRACT

A method for defining an area of interest or a trip line using a camera by tracking the movement of a person within a field of view of the camera. The area of interest is defined by a path or boundary indicated by the person's movement. Alternatively, a trip line comprising a path between a starting point and a stopping point may be defined by tracking the movement of the person within the camera's field of view. An occupancy sensor may be structured to sense the movement of an occupant within an area, and to adjust the lighting in the area accordingly if the occupant enters the area of interest or crosses the trip line. The occupancy sensor includes an image sensor coupled to a processor, an input facility such as a pushbutton to receive input, and an output facility such as an electronic beeper to provide feedback to the person defining the area of interest or the trip line.

### CLAIM OF PRIORITY

This application claims priority from U.S. Provisional Patent Application Ser. No. 60/916,192 entitled “Defining An Area Of Interest For Occupancy Sensing” filed May 4, 2007, which is incorporated by reference.

### FIELD

This invention relates to defining an area of interest for image sensing. More specifically, the invention relates to using the motion of an apparatus installer to define an area of interest or a trip line, and to sense an occupant within (or without) the area of interest, or to detect a person crossing a trip line.

### BACKGROUND

Occupancy sensors usually rely on one or more sensors, such as passive infrared (“PIR”) sensors, ultrasonic sensors, audible sound sensors and the like, to detect when a person is present in a room. This information can be used, for example, to turn on a light or adjust an environmental control such as a thermostat. PIR and ultrasonic sensors work by detecting motion within their field of view, while audible sound sensors report the intensity of sound received at a microphone. These sensors are often of limited and/or uncertain coverage: PIR and ultrasonic sensors may detect motion outside the boundaries of the room or space to be monitored, while sound sensors may be unable to distinguish between moderate sounds within the room and loud sounds from outside the room. In particular, a PIR sensor's area of sensitivity may “spill” into places where detected motion is not desired to affect the controlled device. For example, a light within a room should not be turned on if someone merely walks past the door, even if the sensor can “see” the hallway beyond the door.

In the related field of physical security, optical methods (e.g., infrared or visible-light cameras) may be used to detect intruders directly (rather than by detecting an intruder's movements or noises). Security systems often include a computer, so a sophisticated user interface may be used to set up boundaries between areas visible to the camera that are to be monitored, and visible areas that are not to be monitored. For example, an image depicting the camera's complete field of view can be presented to a system operator, who draws lines to indicate areas of interest that should be monitored automatically.

As infrared and visible-light cameras become less expensive, it becomes attractive to incorporate them into occupancy sensors to provide improved occupant detection accuracy. However, it is not economically practical to provide a complete computer interface solely for configuring a device whose principal purpose is to output a simple binary signal indicating when a person is present within a room or other monitored area. New methods for configuring areas of interest in an image-based occupancy sensor may be of use this field.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a block system diagram showing some components that may be present in an occupancy sensor that implements an embodiment of the invention.

FIG. 2 illustrates an embodiment of a technique for defining an area of interest according to some of the inventive principles of this patent disclosure.

FIGS. 3A and 3B show additional examples of areas of interest that can be defined according to embodiments of the invention.

FIG. 4 shows how an embodiment of the invention is used to establish a trip line for an occupancy sensor.

FIG. 5 illustrates a directional trip line.

FIG. 6 shows how characteristics of an area of interest or a trip line may be set by an installer according to an embodiment of the invention.

FIGS. 7A and 7B show details of a preferred embodiment of the invention.

FIG. 8 is a flow chart outlining a method for setting an area of interest or a trip line.

FIGS. 9A and 9B outline a method of operating an occupancy sensor using an area of interest or a trip line configured according to an embodiment of the invention.

### DETAILED DESCRIPTION

Embodiments of the invention specify methods for configuring an image-based occupancy sensor device. These methods can be used when the occupancy sensor has only limited user-interface capabilities. For example, some methods can be used even if the occupancy sensor has only a single user-input means such as a button, and a single user-output means such as an indicator light, a buzzer or a beeper. These methods are convenient and intuitive, so they may also be used to configure occupancy sensors and similar image-based human-detection systems that have more sophisticated input and output capabilities.

Some of the inventive principles of this patent disclosure relate to techniques for using the motion of a person to define an area of interest or to define a trip line. Further, some of the inventive principles of this patent disclosure relate to techniques for occupancy sensing, in particular, for sensing the presence or motion of a person in or around the area of interest or the trip line. In one embodiment, lighting levels can be adjusted in or about the area of interest responsive to sensing the person. In another embodiment, a security alarm can be triggered responsive to sensing the person.

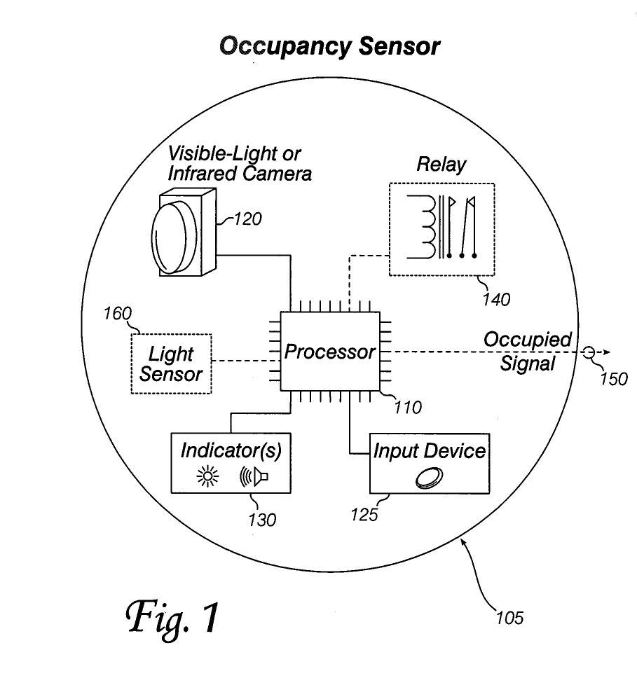

FIG. 1 is a system block diagram of an occupancy sensor 105 according to some of the inventive principles of this patent disclosure. The occupancy sensor 105 may include an image sensor 120 coupled to a processor 110 that is programmed to identify a person or occupant in the scene image captured by the image sensor. The processor 110 may be programmed to implement a sequence of actions while commissioning the occupancy sensor 105, or upon sensing the presence of the occupant. To perform a commission (“area definition” or “configuration”) operation, the image sensor 120 and processor 110 may be arranged and programmed to define an area of interest by monitoring the motion of an installer as the installer walks the periphery of the area of interest. During normal operation (i.e.., non-commission operation), the occupancy sensor 105 may be structured and arranged to detect when a person enters the area of interest or crosses a configured boundary (“trip line”).

In one embodiment, the image sensor 120 may be a visible-light or infrared (“IR”) camera and the processor 110 may be a microcontroller or digital signal processor (“DSP”). The image sensor 120 and the processor 110 may be placed in a housing similar to that of existing occupancy sensors. The occupancy sensor 105 may also include an input device 125 such as a momentary-contact pushbutton, among other possibilities, to initiate the commission operation. During the commission operation to define the area of interest, the processor 110 and the image sensor 120 may be programmed to follow the installer's feet as much as possible so that the area of interest does not bleed out of room entryways. As a result, during normal operation (i.e., non-commission operation), “false-on” errors are eliminated or reduced when a person walks past an entryway without entering the configured area of interest.

The occupancy sensor 105 may include one or more indicators 130, such as a light-emitting diode (“LED”) or an electronic beeper, to provide feedback to the person performing the commission operation. For example, if the installer leaves the camera's field of view during the commission operation to define the area of interest, the electronic beeper may sound continuously until the person reestablishes a position within the field of view. These inventive principles are described more fully with respect to the figures below.

Some occupancy sensors according to embodiments of the invention may include a relay 140 for controlling electrical power to a load, or a light sensor 160 for measuring the ambient light in the vicinity of the occupancy sensor and modifying its operational logic as described below. Some occupancy sensors may emit an “Occupied” signal 150 to alert another system component that the occupancy sensor has detected certain events or conditions.

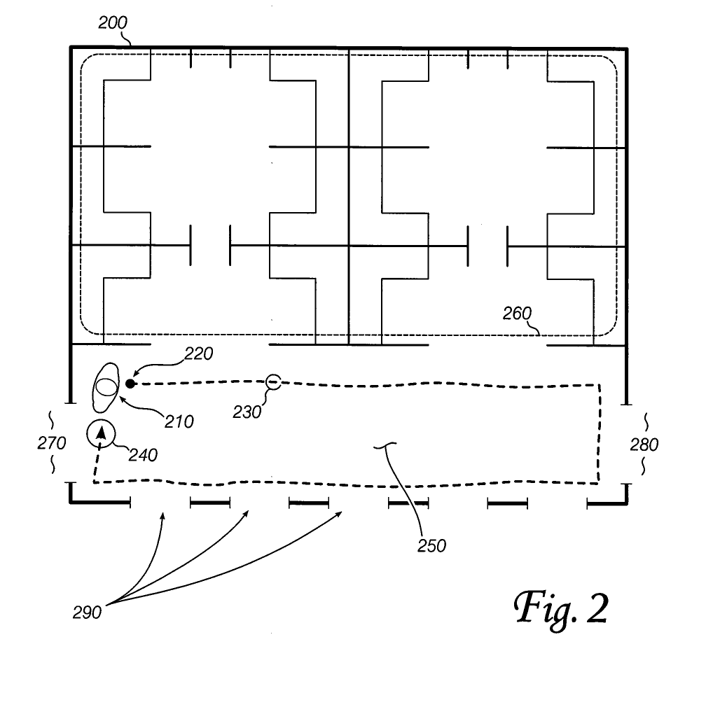

FIG. 2 illustrates a technique for defining an area of interest according to some of the inventive principles of this patent disclosure. A building 200 (or a portion thereof) includes a hallway having entryways at either end. An area generally designated 260 contains a number of workers' cubicles. Suppose it is desired to automatically turn on lights in the hallway when someone is present there, and to automatically turn the lights off after the last person leaves. A prior-art occupancy sensor may be able to accomplish this task, but such a sensor may also be triggered by movement in the cubicle area and turn the hall lights on even though no one is present.

An occupancy sensor implementing an embodiment of the invention may be configured by an installer 210, who walks along a path 230 from its beginning 220, around an area of interest 250, and returning to a point 240 near the beginning. As described in greater detail below, the occupancy sensor stores information about the area of interest, and later, during normal operations, will turn the lights on when someone is present in the area of interest, but will ignore people in the cubicle area 260 or outside the hallway in areas designated 270 and 280, even though those areas may be within the camera's field of view. Some occupancy sensors may include an ambient light sensor so that the hall lights will not be turned on if sufficient natural light is available from windows 290.

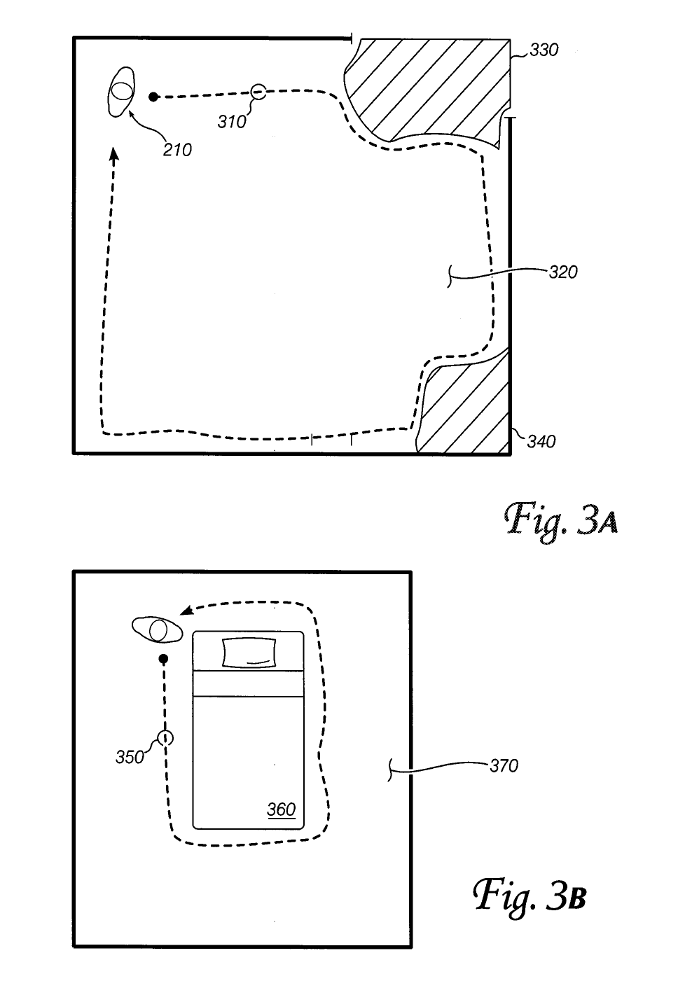

FIG. 3A shows installer 210 defining an irregularly-shaped area of interest 320 by walking clockwise along path 310. Area of interest 320 excludes shaded areas 330 and 340; people present in or walking through these areas will not cause the occupancy sensor to turn lights on or off.

FIG. 3B shows another example of an area of interest. In this illustration, the installer walks counter-clockwise along path 350. An embodiment of the invention can detect the installer's direction of travel, and store information about an area of interest that excludes the vicinity of bed 360. In other words, an occupancy sensor configured by an installer walking counter-clockwise along path 350 would respond to people present in area 370, while ignoring anyone in bed 360. This capability might be useful, for example, to configure an occupancy sensor for controlling lights in a hospital room, where it is not desired to automatically turn the lights on whenever a patient is in bed, but only when someone is in the room but not in bed.

Some embodiments may permit the installer to configure multiple areas of interest. These areas may be disjoint or overlapping. Programmed logic within an occupancy sensor may take different actions based on occupancy or occupancy changes within one or more of the multiple areas. For example (returning to the hospital-room sample environment), an embodiment may raise the light level from off to a low level if someone enters the room while a patient is in bed, or from off to full-on if someone enters the room while no one is in bed. In other environments, multiple areas of interest can be used to set lighting levels appropriately for different portions of a room: to an intermediate level for portions with adequate ambient light, or to a higher level if someone enters a portion that is ordinarily underlit.

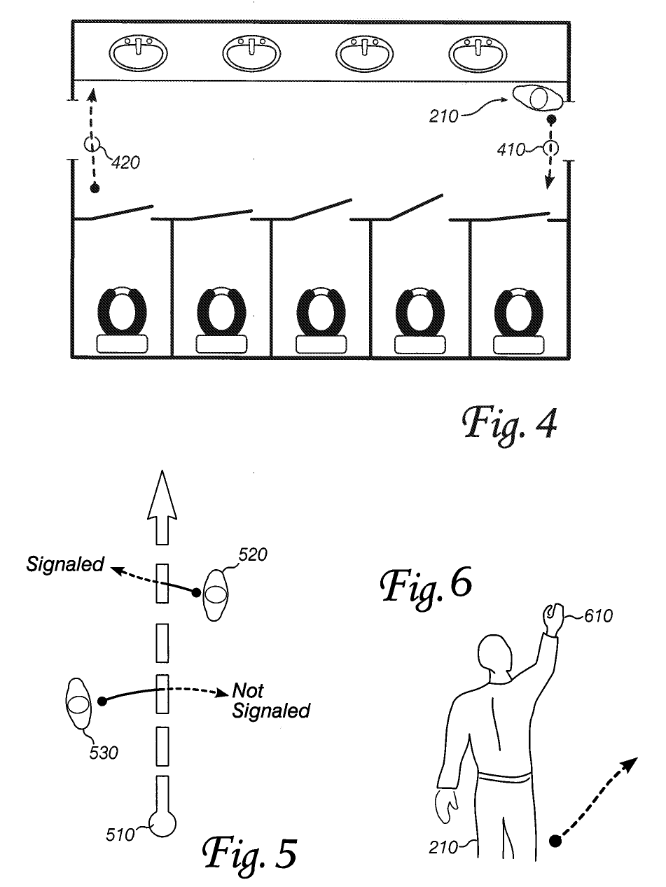

In some environments, an occupancy sensor's optical field of view may be obstructed, so occupants may become invisible to the camera unpredictably. Nevertheless, it may be desired to control the lights (or perform some other action) automatically when at least one person is present in the area. Consider, for example, the multi-stall restroom shown in FIG. 4. Even if an area of interest is configured for the main portion of the room, occupants in stalls may be invisible to the camera, and the occupancy sensor may erroneously conclude that the restroom is unoccupied.

To remedy this situation, according to another embodiment of the invention, trip lines 410 and 420 are configured at the entrances to the restroom. A trip line is similar to the boundary of an area of interest, as described above, but it is not closed (i.e., the start and end points of the path are different). When the occupancy sensor detects a person crossing a trip line to enter the room, it increments a counter, and when it detects a person crossing a trip line to exit, it decrements the counter. When the counter is zero, the lights may be turned off.

FIG. 5 shows that a trip line may be directional: trip line 510 causes a signal if it is crossed from right to left (520), but not if it is crossed from left to right (530). Omnidirectional trip lines (not shown) may signal if crossed in either direction.

FIG. 6 shows that an installer 210 can indicate directionality of a trip line by raising his arm 610 while walking along the trip line. Other gestures that can be distinguished by the camera in the occupancy sensor can also be used to set characteristics of a trip line or area of interest. Alternatively, an installer may carry a beacon such as a flashlight or light-emitting diode (“LED”) light to aid the occupancy sensor in tracking the installer as he moves about in the camera's field of view. Such gestures and/or beacons may be used in connection with area-of-interest configuration as well.

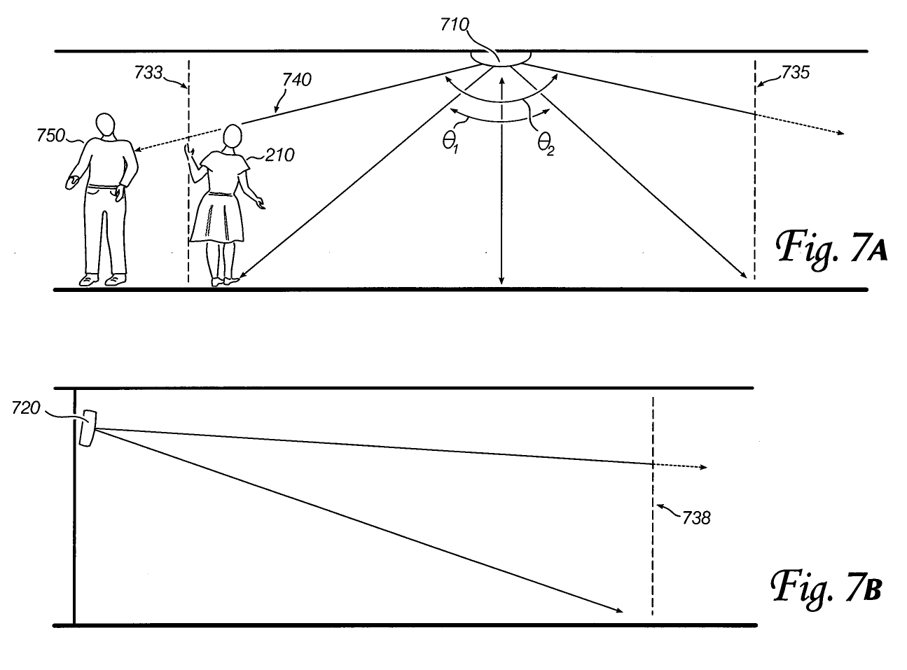

FIGS. 7A and 7B show elevation views of a ceiling-mounted occupancy sensor 710 and a wall-mounted occupancy sensor 720, respectively. These figures show that it is preferable to track the feet of an installer 210 as she walks along a path bounding an area of interest or a trip line. (Lines 733, 735 and 738 show the imaginary walls standing over the area of interest boundary or trip line.) If the occupancy sensor tracks the installer's head (see line 740), then the location of the area of interest boundary or trip line may be uncertain, and installers of different heights may produce different areas of interest, even if they walk identical paths. Thus, a person 750 standing outside the intended boundary 733 might be identified incorrectly as standing within the area of interest.

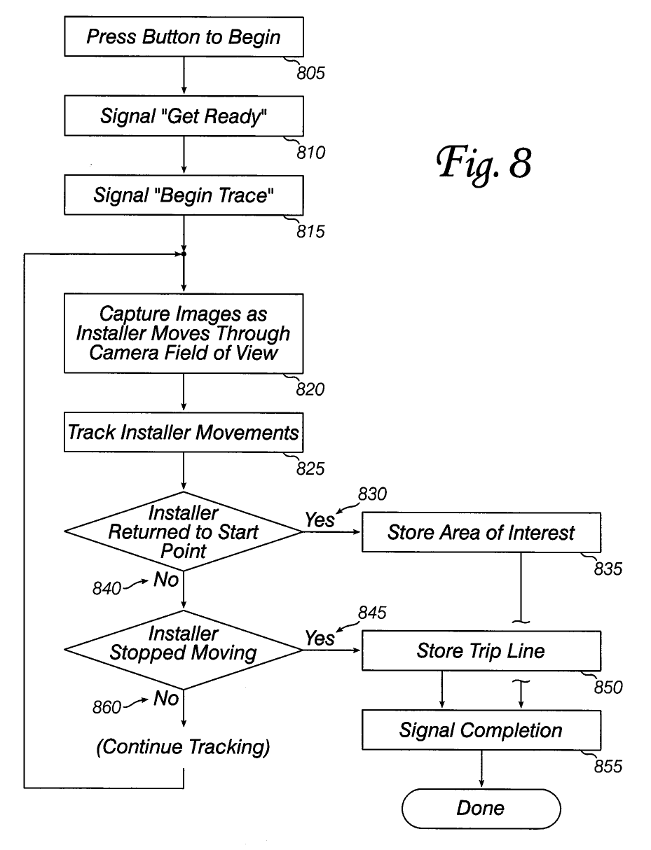

FIG. 8 is a flow chart outlining a method for configuring an area of interest or a trip line. The installer activates a user input facility (e.g., the push button on the occupancy sensor) to begin (805). This may clear any currently-stored areas of interest and trip lines. If it is desired to add a new area of interest or trip line, the installer may push the button twice, or push a different button (if available).

The occupancy sensor signals the user to get ready (810) by beeping, blinking, or producing another notification signal. At this time, the installer moves to the start of the area of interest boundary or trip line.

After a brief preparatory period, the occupancy sensor signals the installer to begin walking along the path (815). Then, a series of images are captured as the installer moves through the environment and the camera's field of view (820). The processor analyzes these images to track the installer's movements (825). Software to perform this analysis and tracking is available commercially; one vendor selling such software is the Object Video Corporation of Reston, Va.

If the installer has returned to the start point (830), then information about the path traversed is stored as an area of interest (835). If the installer has not returned to the start point (840), but he has stopped moving for longer than a predetermined time (e.g., three seconds) (845), then information about the path traversed is stored as a trip line (850). After storing information about an area of interest or a trip line, the occupancy sensor may beep or flash to signal that the operation is complete (855). If the installer has neither returned to the start point (840) nor stopped moving (86o), the system continues to track his movements.

As discussed in reference to FIGS. 2, 3A and 3B, if the installer completes a circuit by returning to his starting position, the occupancy sensor may form a closed path by connecting the start and end points, and then divide the environment into a first portion “outside” the path and a second portion “inside” the path. One portion is selected as the area of interest, depending on (for example) the direction the user walked along the path. For a directional trip line, a direction substantially perpendicular to the path may be identified based on the user's direction of travel or a gesture made while traversing the path. Information about this direction may be stored with the trip line.

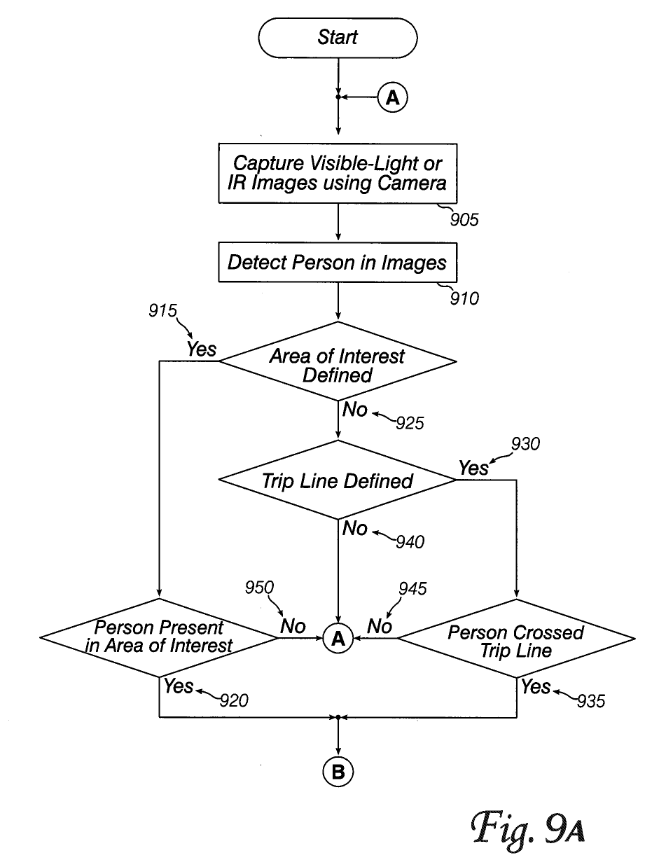

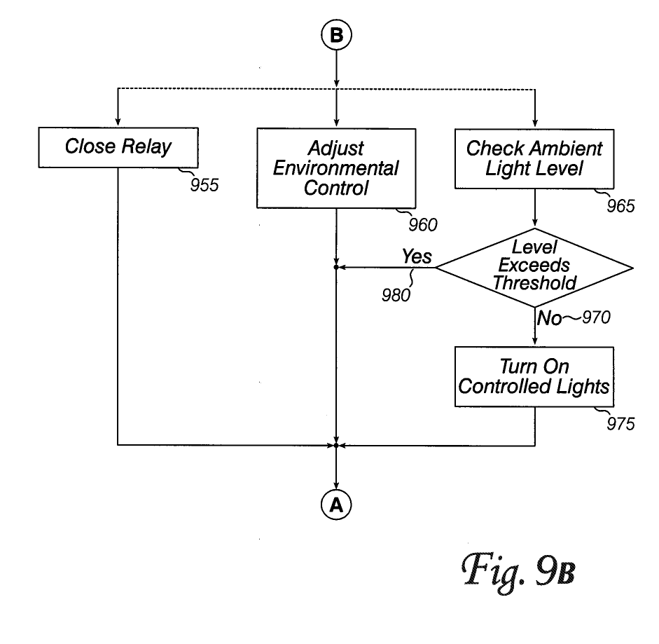

An occupancy sensor that has been configured with one or more areas of interest and/or trip lines as described above may commence normal operations as described in the flow chart shown in FIGS. 9A and 9B. During these operations, the occupancy sensor captures visible light or infrared (“IR”) images using a camera (905). The processor analyzes these images to detect a person (910). If an area of interest is defined (915), and the detected person is present in the area of interest (920), one or more of the actions described in FIG. 9B may be taken. If no area of interest is defined (925), but a trip line is defined (930), and the person crossed the trip line (935), then one or more of the actions described in FIG. 9B may be taken. If no trip line is defined (940), or the person did not cross the trip line (945) (including crossing the trip line in the “wrong” direction); or if there is an area of interest (915) but no one is present in it (950), the occupancy sensor continues to capture and analyze images.

If a person is present in an area of interest, or has crossed a trip line, then (referring to FIG. 9B) the occupancy sensor may close a relay (955) to turn on a light or other electrical load; or adjust an environmental control (960) such as a thermostat or ventilation system. In some embodiments, after detecting a person, the occupancy sensor may further check an ambient light level (965). If the light level exceeds a threshold (980), no further action may occur. If the ambient light level is below the threshold (970), then the occupancy sensor may turn on one or more lights that it controls (975). After taking one of the actions discussed in reference to FIG. 9B, the system returns to A on FIG. 9A, where it resumes capturing and analyzing images from the camera.

An occupancy sensor operating as described above may also contain a timer that is initialized to a time-out value when someone is present in the area of interest or has crossed a trip line. If the time-out period expires, the occupancy sensor may turn off the controlled light, open the relay, restore the environmental control to its “off” state, or cease producing an “occupied” signal for use by another subsystem or component.

An embodiment of the invention may be a machine-readable medium having stored thereon data and instructions to cause a programmable processor to perform operations as described above. In one preferred embodiment, the instructions and data may be stored in a non-volatile memory (e.g., a read-only memory (“ROM”), electrically-eraseable, programmable read-only memory (“EEPROM”) or Flash memory) of a microcontroller. Such a microcontroller may be installed as a component of an occupancy sensor as described above, with a visible-light or infrared camera, at least one user input facility, and at least one user output facility.

In other embodiments, the operations might be performed by application-specific integrated circuits (“ASICs”) that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In the preceding description, numerous details were set forth. It will be apparent, however, to one skilled in the art, that the present invention may be practiced without these specific details. In some instances, well-known structures and devices are shown in block diagram form, rather than in detail, to avoid obscuring the present invention.

Some portions of the detailed descriptions were presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, compact disc read-only memory (“CD-ROM”), and magnetic-optical disks, read-only memories (“ROMs”), random access memories (“RAMs”), erasable, programmable read-only memories (“EPROMs”), electrically-erasable read-only memories (“EEPROMs”), Flash memories, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes a machine readable storage medium (e.g., read only memory (“ROM”), random access memory (“RAM”), magnetic disk storage media, optical storage media, flash memory devices, etc.), a machine readable transmission medium (electrical, optical, acoustical or other form of propagated signals (e.g., carrier waves, infrared signals, digital signals)), etc.

The applications of the present invention have been described largely by reference to specific examples and in terms of particular allocations of functionality to certain hardware and/or software components. However, those of skill in the art will recognize that a lighting control protocol consistent with the scope of the present invention can also be implemented by software and hardware that distribute the functions of embodiments of this invention differently than herein described. Such variations and implementations are understood to be captured according to the following claims.

We claim:

1. A method for operating an apparatus with a camera and at least one user input facility, the method comprising:
receiving an input signal from a user via the at least one user input facility;
capturing a series of digital images of the user in an environment with the camera in response to the input signal;
tracking movement of the user through the environment to identify a path; and
storing information corresponding to the path in a memory.

2. The method of claim 1, further comprising:
detecting a pause in the movement of the user, said pause exceeding a predetermined duration;
terminating the tracking operation after the pause; and
commencing the storing operation after the pause.

3. The method of claim 1, further comprising:
repeating the receiving, capturing, tracking and storing operations to store information corresponding to a second path in the memory.

4. The method of claim 1, further comprising:
connecting a start point of the path to an end point of the path to form a closed path;
dividing the environment into a first portion on one side of the closed path and a second portion on another side of the closed path; and
selecting one of the first portion and the second portion as an area of interest based on a direction of the movement of the user through the environment.

5. The method of claim 4, further comprising:
capturing an image of the environment with the camera after the selecting operation;
analyzing the image of the environment to detect a person in the environment; and
producing a signal if the person is in the area of interest.

6. The method of claim 1, further comprising:
identifying a direction substantially perpendicular to the path; and
storing the direction with the information corresponding to the path.

7. The method of claim 6 wherein identifying comprises selecting a direction from right to left as viewed from a start of the path to an end of the path.

8. The method of claim 6 wherein identifying comprises detecting a gesture of the user as the user moves through the environment.

9. The method of claim 1, further comprising:
capturing a second series of digital images of the environment with the camera after the storing operation;
detecting a person moving through the environment by analyzing the second series of digital images; and
producing a signal if the person moving through the environment crosses the path.

10. The method of claim 1, further comprising:
emitting a first audible signal to alert the user to prepare to move along the path;
emitting a second audible signal to alert the user to begin moving along the path;
emitting a third audible signal if the user returns to a beginning of the path; and
emitting a fourth audible signal to indicate the storing operation.

11. A computer-readable medium storing data and instructions to cause a programmable processor to perform operations comprising:
analyzing a first series of digital images of an environment to identify a first person moving through the environment;
constructing a path corresponding to the motion of the first person through the environment;
storing information related to the path in a memory;
analyzing a second series of digital images of the environment to identify a second person moving through the environment; and
producing a detection signal if the second person crosses the path.

12. The computer-readable medium of claim ii, storing additional data and instructions to cause the programmable processor to perform operations comprising:
monitoring an ambient light level in the environment; and
producing the detection signal only if the second person crosses the path and the ambient light level is below a predefined threshold.

13. The computer-readable medium of claim ii, storing additional data and instructions to cause the programmable processor to perform operations comprising:
detecting a configuration signal from a user-input device to initiate the first analyzing operation; and
emitting a confirmation signal to a user-output device to notify the first person of the storing operation.

14. The computer-readable medium of claim ii, storing additional data and instructions to cause the programmable processor to perform operations comprising:
identifying feet of the first person in the first series of digital images, wherein
constructing the path corresponding to the motion of the first person through the environment is constructing the path corresponding to the motion of the feet of the first person through the environment.

15. An apparatus comprising:
a digital camera;
a user input device;
a user output device;
a programmable processor coupled to the digital camera, the user input device, and the user output device; and
a non-volatile storage medium containing data and instructions to cause the programmable processor to perform operations including:
recording a path corresponding to movement of a first person through a field of view of the digital camera in response to an activation of the user input device;
notifying the first person of a successful recording using the user output device;
detecting a second person moving through the field of view of the digital camera; and
producing a detection signal if the second person crosses the path.

16. The apparatus of claim 15, further comprising:
a relay to control electrical current to a load, wherein
the detection signal causes the relay to close.

17. The apparatus of claim 16, further comprising:
a light sensor to detect an ambient light level in a vicinity of the apparatus; and
additional data and instructions in the non-volatile storage medium to prevent the relay from closing if the ambient light level exceeds a predetermined threshold.

18. The apparatus of claim 16, further comprising:
a timer, wherein
the detection signal causes the timer to begin measuring a time-out period, and
the relay is opened if the time-out period expires.

19. The apparatus of claim 15 wherein the digital camera is a visible-light camera.

20. The apparatus of claim 15 wherein the digital camera is an infrared camera.

21. The apparatus of claim 15 wherein the user input device is a momentary pushbutton.

22. The apparatus of claim 15 wherein the user output device is one of a light-emitting diode (“LED”) or an audible beeper.
